(19) United States
(12) Patent Application Publication
(10) Pub. No.: US 2017/0155160 A1
(43) Pub. Date: Jun. 1, 2017

(54) Fuel Cell System

(71) Applicant: Daimler AG, Stuttgart (DE)

(72) Inventor: Gustav BOEHM, Ueberlingen (DE)

(73) Assignee: Daimler AG, Stuttgart (DE)

(21) Appl. No.: 15/313,814

(22) PCT Filed: May 28, 2014
(86) PCT No.: PCT/EP2014/001457

§ 371 Date: Nov. 23, 2016

(51) Int. Cl. H01M 8/04223; H01M 8/04746; H01M 8/2475; H01M 8/04228; H01M 8/04089

(52) U.S. Cl. CPC H01M 8/04231; H01M 8/04228; H01M 8/04097; H01M 8/2475; H01M 8/04753; H01M 2250/20

(57) ABSTRACT

A fuel cell system is disclosed. The fuel cell system has at least one fuel cell stack which is arranged in a housing. The housing has at least one ventilation connection to the surroundings or to another volume. The ventilation connection has a valve device.

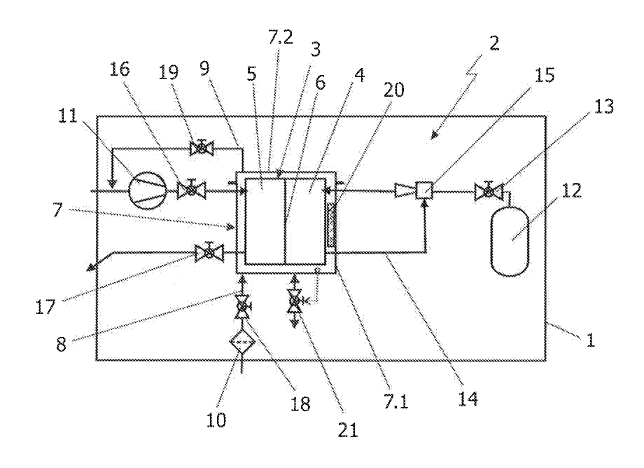

The invention relates to a fuel cell system having at least one fuel cell stack of the type more precisely defined in the preamble of claim 1. In addition, the invention relates to a method for switching off such a fuel cell system, and to its use.

Fuel cell systems are known in the general prior art. They typically have a so-called fuel cell stack which is made of stacked, individual cells. Each of the individual cells has an anode region, a cathode region, and a region for a cooling fluid. The fuel cell stack is created by stacking the individual fuel cells on top of each other, thereby providing a voltage defined by the individual cells, which are typically connected in series. The cathode regions, the anode regions, and the regions for cooling water in the individual cells are sealed off from each other and from the environment of the fuel cell stack via seals. The seals in the entire fuel cell stack are comparatively long, such that seal lengths on the anode side are 200 to 300 mm, and on the cathode side are exactly the same, for a fuel cell stack in the power class up to 100 kW. The problem in this case is that hydrogen, in particular, is able to diffuse relatively easily through the seal materials which are typically used. For this reason, the fuel cell stack is typically arranged in a housing which mechanically protects the stack and which captures the small amount of hydrogen which escapes by diffusion and via seal defects, to vent the same. An air stream, by way of example, can flow through the housing via ventilation lines, such that escaped hydrogen can be removed so as to prevent a concentration of the hydrogen in the surroundings of the fuel cell system, which is a threat to safety.

One of the problems of fuel cells as known from DE 10 2009 036 198 A1, for example, is that the lifetime of a PEM fuel cell stack is negatively influenced by degradation mechanisms. A core problem here arises when oxygen is present in the anode region of fuel cell when the fuel cell is started, and hydrogen is introduced during the electrical start. In this case, a hydrogen/oxygen recombination front runs over the anode catalyst, and an electrical potential difference occurs between the input and output sides of the fuel cell stack due to the concentration differences. The electrochemical processes occurring as a result produce long-lasting damage to—most of all—the catalyst on the cathode end, and potentially, to a small degree, to the catalyst on the anode end. To remedy this problem, a construction is described in the named document which significantly reduces the penetration of oxygen into the cathode end during standby—that is, when the fuel cell system is switched off, by using a system bypass valve. The cause of this penetration of oxygen is the pressure difference between the input and the output of the fuel cell system for example, in the case of a vehicle, due to wind effects or to thermal convection effects. The construction having a system bypass is extraordinarily simple and efficient.

DE 10 2007 059 999 A1 is also hereby noted among the prior art. In this document, shut-off valves in an air intake line and an air outlet line to the cathode chamber are used in place of a stack bypass valve to accordingly prevent fresh oxygen from penetrating into the fuel cell, and to therefore also achieve a positive effect on the service life of the stack.

However, in these two methods, there is the problem that hydrogen diffuses not only from the anode chamber into the cathode chamber, but also from the anode chamber—and somewhat later, potentially from the cathode chamber—into a housing around the fuel cell stack. This occurs because of the long lengths of the seals in a fuel cell stack, and because of the seal material being more or less permeable to the diffusion of gases—primarily for hydrogen, but also air components and steam. Accordingly, the hydrogen present in the anode chamber after the stack is switched off volatilizes first, by diffusion. The remaining volume of hydrogen is then degraded on the electrode catalysts by recombination as the result of atmospheric oxygen penetration. Oxygen can penetrate into the fuel cell stack via two pathways. First, it can penetrate the stack via the normally open air feed channels, due to air drafting or to diffusion. Also, it can penetrate into the fuel cell stack by seal diffusion, via the housing which is normally open to the atmosphere. As soon as the oxygen has displaced the hydrogen on the anode, damage occurs when the stack is restarted.

The practice of designing a fuel cell housing around a fuel cell stack as a part of the hydrogen intake line or discharge line is also known from the further general prior art as disclosed in DE 10 2009 018 105 A1. Hydrogen which diffuses out of the fuel cell system therefore once again incorporated into the hydrogen circulation during the operation of the fuel cell system, and consequently is not lost, on the one hand, while on the other hand there is no chance of a dangerous, explosive mixing with air from the surroundings. The disadvantage of this construction is that the housing is subjected, over its relatively large wall surface areas, to the operating hydrogen pressure.

The problem addressed by the present invention is that of avoiding the named disadvantages, and of providing a fuel cell system and a method for switching off such a fuel cell system, which has a very simple construction and enables a very long service life of the fuel cell stack.

According to the invention, this problem is addressed by a fuel cell system having the features of the characterizing portion of claim 1. Advantageous embodiments and implementations are found in the associated dependent claims. In addition, a method having the features of the characterizing portion of claim 7 addresses the problem. Advantageous implementations thereof are likewise found in the dependent claims. Finally, a particularly preferred use of the fuel cell system is provided in claim 10.

In the fuel cell stack according to the invention, a housing is arranged around the fuel cell stack in the known manner. The housing in this case has at least one ventilation connection to the surroundings, or to another volume. This at least one ventilation connection—typically, there will be two ventilation connections—ensures that hydrogen potentially escaping during the operation of the fuel cell stack can be discharged and rendered harmless. A further function of the housing ventilation is normally drying out the steam which escapes from the fuel cell stack by diffusion and through potential small leaks. However, this is not relevant for this invention. Moreover, the at least one ventilation connection according to the invention has a valve device. If a ventilation inlet line and a ventilation outlet line are installed, at least one, and preferably both, of the lines have a valve device. Via such a valve device—for example a magnetic valve, a flap, or the like, the housing can be tightly closed when needed.

This establishes the decisive advantage. When the fuel cell stack is switched off, primarily the hydrogen from the anode chamber diffuses to the cathode chamber, or passes over to the same through small membrane or seal leaks. If oxygen is present in the cathode chamber, there is a reaction on the cathode catalyst up to the point where the oxygen is consumed—as long as a sufficient volume of hydrogen has been stored in and/or brought into the anode chamber at the shutoff. The diffusion of hydrogen comes to a halt when the partial pressures of hydrogen at the anode and the cathode are equilibrated.

In addition, more or less in parallel thereto, hydrogen diffuses first out of the anode chamber, and then also out of the cathode chamber, into the surroundings of the fuel cell stack, and therefore into the housing. A certain hydrogen concentration then likewise arises inside the housing. As soon as there is no concentration gradient between the housing and the interior of the fuel cell system, this process is also ended—as long as there is a sufficient volume of hydrogen in the anode chamber when the fuel cell system is switched off. At this point, there is a hydrogen atmosphere in both the interior of the fuel cell system and in the housing. The fuel cell system can then be restarted without the simultaneous occurrence of the degradation effects which reduce the service life.

In a further, very practical design of the fuel cell system according to the invention, the housing can also be made of at least two housing parts, between which are arranged one or more housing seals. In this case, the length of the housing seal is much less than the total length of seals in the fuel cell stack itself. This difference in the seal lengths, which is preferably greater than a factor of 100, and particularly preferably greater than a factor of 300, ensures that the seal length between the housing and the surroundings is much less than the seal length between the interior of the fuel cell stack and the housing. As a result of even just this difference in the seal lengths, hydrogen is largely prevented from diffusing out of the housing, and/or air is prevented from subsequently diffusing into the housing, since the seal lengths which can allow this are much less than those of the fuel cell stack itself. In a particularly advantageous implementation, the housing seal can also be made of a particularly diffusion-inhibiting material, which is much simpler to realize in the construction of the housing than in the construction of the fuel cell stack itself. However, this is not absolutely necessary since the primary effect is already achieved by the length difference between the housing seals and the seals of the fuel cell stack.

In a further embodiment of the fuel cell system according to the invention, the housing is equipped with a valve which opens according to whether pressure differences with to the atmosphere (overpressure and/or underpressure) have been exceeded, in order to limit these pressure differences. Such a configuration can be expedient if weight-saving space-saving housings with low mechanical stability will be used. In any case, the assumption is made that these pressure differences are less than, or much less than, 0.1 bar, such that it is optionally possible to dispense with a valve, and/or it is only necessary secure one pressure direction.

In one advantageous implementation of the fuel cell system according to the invention, a catalytic recombination device for reacting hydrogen, particularly with oxygen, can also be arranged in the housing. Such a recombination device can particularly be included for the purpose of reacting hydrogen and oxygen in the housing on a catalyst which is suitable for the reaction. In the embodiment of the invention selected here, having a housing which can be sealed off from the surroundings when the fuel cell system is shut off, this recombination device has the decisive advantage that oxygen is consumed by the hydrogen which escapes the anode chamber and enters into the housing, such that a critical hydrogen/oxygen mixture cannot form, and overall, after a certain shutdown time, the same hydrogen partial pressure and/or the same hydrogen concentration prevails throughout. In this way, it is possible to largely halt diffusion processes, and it is possible to ensure that a hydrogen atmosphere is maintained in the housing, and most of all in the fuel cell stack over a very long time period of several hours, without a combustible hydrogen/oxygen mixture forming in the housing. In this way, it is possible to start the fuel cell system at any time without critical processes which negatively influence the service life.

This is particularly efficient if air is prevented from flowing into the cathode chamber of the fuel cell stack. For this reason, as mentioned in the prior art named above, a stack bypass valve can be included, and/or shutoff valve devices can preferably be used, in the air intake line and the air outlet line. This measure can reduce or entirely prevent the penetration of oxygen after the stack is switched off. In this way, it is possible to further improve the effect using a relatively small excess of hydrogen, and to significantly increase the time period over which a hydrogen atmosphere can be maintained in the fuel cell stack and the housing.

In the method according to the invention for switching off such a fuel cell system, the valve device is accordingly closed in the at least one ventilation connection. The air feed to the cathode chamber of the fuel cell stack is shut off, and the undesired air feed—for example the airstream due to convection or to outside wind—is at least reduced, or is fully inhibited, by closing the air inlet and/or the air outlet. Subsequently, hydrogen is conveyed into the anode chamber of the fuel cell stack up to a prespecified pressure or a prespecified hydrogen volume. As a result, the fuel cell system can be easily and efficiently switched Due to the introduction of hydrogen up to a prespecified pressure, or the introduction of a prespecified volume of hydrogen, a certain hydrogen excess and/or overpressure is in the region of the anode chamber. During the time period following the shutoff of the fuel cell system, the hydrogen can then move into both the cathode chamber and the housing the manner described above. After a certain time, an equilibrium state is established such that there is a hydrogen atmosphere both in the interior of the fuel cell itself, and in the housing, which can accordingly be maintained over a very long period of time without addition of hydrogen or another manner of monitoring of the fuel cell system. In this way, it possible to ensure, over a comparatively long shutoff period of, ideally, more than 10 to 24 hours, that upon re-starting, the conditions are in place which enable a restart without damage to the fuel cells, and/or a reduction in the service life of the fuel cells.

In a further, very expedient formulation of the method according to the invention, the oxygen present in the cathode chamber can also be at least partially depleted before, during, and/or after the feed of hydrogen. Such a depletion of oxygen is certainly advantageous, but in principle is not absolutely necessary. However, this allows for a very short time period up to the establishment of the desired equilibrium conditions—for example as a result of an electrical “consumption” of the residual oxygen in the cathode chamber, such that overall an advantageous state of the fuel cell stack and/or of the entire fuel cell system, as concerns a later restart, can be achieved more quickly and with a lesser amount of hydrogen.

A particularly preferred use of the fuel cell system is in a vehicle, serving to provide drive power. The drive power in this case can be entirely or at least partially provided by the fuel cell system. In particular, such fuel cell systems in vehicles are subjected, on the one hand, to frequent shutoffs and restarts, and on the other hand must have a simple, efficient, and very reliable construction. The design of the fuel cell system according to the invention, and the particularly advantageous method for switching off the fuel cell system which enables a restart without noteworthy degradation, is therefore primarily suited to use in a vehicle, since all the advantages of the invention are particularly well-expressed in this application.

Additional advantageous embodiments of the fuel cell system, and of the method for switching off such a fuel cell system, are found in the remaining dependent claims, and are described clearly in greater detail in the embodiments below, with reference to the figure.

The single attached figure shows a fuel cell system indicated in principle according to the invention, in a vehicle.

A vehicle 1 is indicated schematically in the single attached figure. A fuel cell system 2 is provided to supply electrical drive power for the vehicle 1. The core of the fuel cell system 2 in this case is a fuel cell stack 3 which is constructed in the known manner from a plurality of individual cells, with PEM technology. Each of these individual cells has a cathode region, an anode region, and a cooling water region. In the explanation of the invention, the anode regions and the cathode regions are particularly relevant. In the illustrated figure, for this reason only one anode chamber 4 and one cathode chamber 5 are indicated in principle, with a proton exchange membrane 6 arranged in-between. These represent the plurality of anode regions, cathode regions, and proton exchange membranes in the fuel cell stack 3. The fuel cell stack 3 is arranged in a housing 7 which consists of a first housing part 7.1 and a second housing part 7.2—for example a housing cover. A housing seal which cannot be seen here is arranged between the housing parts 7.1, 7.2. The housing 7 also has two ventilation connections 8, 9. The ventilation connection 8 is designed as a ventilation intake line 8, and is connected to the surroundings of the housing 7 via an air filter 10 shown here, by way of example. The second ventilation connection 9 is designed as a ventilation compartment 9, and opens into an air intake line to the cathode chamber 5 of the fuel cell stack 3—specifically in front of a compressor 11, as the air conveying device, in the direction of flow. However, other discharge paths can be contemplated. During the operation of the compressor 11, as the air conveying device, the air flows constantly through the housing 7 since air is taken in from the surroundings of the housing 7 via the air filter 10 and the ventilation intake line 8 and discharged out of the housing 7 via the ventilation outlet line 9. An airstream therefore flows through the housing constantly. Hydrogen which may potentially escape from the fuel cell stack 3 is therefore taken in during operation, together with the intake air, and can react on the catalyst of the cathode chamber 5 with the oxygen, thereby being rendered harmless. Alternative designs of the housing ventilation are known to a person skilled in the art from the general prior art, and can likewise be employed in this case. The sole decisive issue is that there is a ventilation of the housing 7 which includes at least one ventilation connection 8, 9—wherein, if both are present, at least one of these has a valve device.

As mentioned above, air is conveyed via an air conveying device 11 into the cathode chamber 5 of the fuel cell system as the oxygen supplier. Hydrogen from the pressurized gas tank 12 is fed to the anode chamber 4 of the fuel cell stack 3. The hydrogen moves the region of the anode chamber 4 via a pressure regulating and dosing valve 13. Unconsumed hydrogen is returned in the known manner via a recirculation line 14 and a gas jet pump as the recirculation conveying device 15, and taken in by the freshly added hydrogen as the propellant gas stream. However, other recirculation conveying devices also be contemplated. What is essential is that the anode chamber, with recirculation, constitutes a space which is typically closed with respect to the atmosphere, and remains closed after the system is switched off. The unconsumed hydrogen following the anode chamber 4 is therefore conveyed in the circulation, and can accordingly be consumed little by little. This so-called anode circulation and/or anode loop is known in the general prior It is illustrated here in a highly simplified manner. In reality, it also comprises a water separator, outlet valves, and the like. This is of lesser importance for the present invention and is therefore not illustrated. However, these elements can be arranged in the anode circulation in the manner which is generally known and conventional for a person skilled in the art.

The housing 7 around the fuel cell stack 3 is constructed to be as impermeable to gas as possible, including the ventilations lines 8, 9, and is built with the least possible seal length in its seal position between the housing parts 7.1 and 7.2. The length of the housing seal between the housing parts 7.1 and 7.2 in this case is particularly substantially shorter than the length of the seals between the individual cells of the fuel cell stack 3 and/or the cathode regions and the anode regions and the surroundings of the fuel cell stack 3. By way of example, for a 100 kW fuel cell system 3, the seal length inside the stack can be approx. 400-600 m in total. The length of the seals in this case is divided relatively evenly between the anode side and the cathode side. If, by way of example, the housing seal between the housing parts 7.1 and 7.2 is made with a total length of approx. 1 m, there is a significant difference in the lengths of the seals. This results as well in a much lower diffusion of hydrogen to the outside should hydrogen be present in the housing 7, and/or a much lower diffusion of oxygen through the housing seal, compared to the seals of the fuel cell system. This achieves a tight seal of the system, comprising the fuel cell stack 3 and housing 7—with respect to hydrogen as well. In addition, the housing seal, if allowed by the construction, can be made of a particularly diffusion-inhibiting material. However, this is not absolutely necessary, because the primary effect is achieved by the length difference between the total length of the seals of the fuel cell stack 3 and the much shorter housing seal.

The approach for the switching off of the fuel cell system 2 in the vehicle 1 is therefore as follows: First, as is generally known and conventional, the feed of air is halted in the known manner by shutting off the air conveying device 11. If hydrogen continues to be supplied, the oxygen remaining in the system can particularly be consumed by a further removal of electrical power - and by way of example storage in a battery. In this ideal case, an oxygen-rich atmosphere is then present in the cathode chamber 5. However, this is not absolutely necessary for the method. At the same time, or subsequently, the possibility of fresh oxygen being supplied, by way of example by convection effects or wind effects, should be prevented or reduced. This can be achieved by a system bypass, for example, as in the prior art named above. However, this can be achieved in a particularly very efficient manner by the shutoff valve devices 16, 17 illustrated in the embodiment, in the air intake line to the cathode chamber 5 and in the air outlet line from the cathode chamber 5. However, an improvement as regards the described damage which occurs at the restart can also be achieved if either a shutoff valve device is present in the air intake line 16 or a shutoff valve device is present in the air outlet line 17, and is closed after the fuel cell system 1 is switched off.

At the same time as the shutoff of the air conveying device 11, valve devices 18, 19 in the ventilation connections 8, 9 are closed. However, an improvement as regards the described damage which occurs at the restart can also be achieved if either a shutoff valve device is present in the ventilation air intake line 18 or a shutoff valve device is present in the ventilation air outlet line 19, and is closed after the fuel cell system 1 is switched off.

The housing 7 is then sealed off from the surroundings. Next, a volume of hydrogen which is adjusted to the system is dosed into the anode chamber 4, by way of example by hydrogen being added up to a prespecified pressure. Then, the feed of hydrogen is shut off, by way of example by closing a hydrogen valve and/or a valve in the pressure regulating and dosing device 13. The pressure and/or the volume of hydrogen in this case are prespecified in such a manner that in each case there is an excess of hydrogen in the anode chamber 4.

After the system is shut off, this excess hydrogen then diffuses through the proton exchange membrane 6 into the cathode chamber 5, and reacts at this site with optionally- optionally-present oxygen on the catalyst of the cathode. Hydrogen also diffuses via the seals of the fuel cell stack 3, both out of the anode chamber 4 and also out of the cathode chamber 5, into the housing 7. This hydrogen diffusion takes place until the concentration and/or partial pressure in the interior of the fuel cell stack 3 and in the interior of the 7 is equilibrated. The diffusion of hydrogen then stops, and a sufficient volume of remains in the fuel cell stack 3. The hydrogen electrode is therefore held at 0V electrochemical potential.

If oxygen diffuses into the housing 7 of the fuel cell stack 3, or is still present in the same, it can particularly recombine on a catalytic recombination device 20 arranged in the housing 7, to form water, such that here as well, oxygen which is potentially present or has diffused is reliably consumed. This is because hydrogen then diffuses out of the fuel cell stack 3 into the housing 7 as a result of the concentration gradient which arises. However, the diffusion of oxygen is largely prevented by the valve devices 18 and/or 19 in the ventilation connections 8, 9, and the comparatively small length of the housing seal between the housing parts 7.1 and 7.2, such that the oxygen in the housing 7 can be entirely depleted. In principle, at the start of the process, a combustible or even explosive mixture of hydrogen and oxygen can occur in the housing 7. This substantially depends on the diffusion speed of the gases and the volumes in each case, as well as on potential external seal leaks. However, appropriate measures can easily achieve a state which is not critical for safety—for example by ensuring the absence of any combustion sources in the housing 7, and/or by designing the housing volume to be so low that the amount of the combustible mixture can be considered non-critical as safety is concerned. In addition, a skillful attachment of the recombination device 20, for example in the form of a coating on the inner wall of the housing, can ensure a rapid degradation of the oxygen, which likewise contributes to ensuring that the ignition point at any moment in time is not reached.

An optional, pressure-dependent reactive valve 21 can be included in the region of the housing 7. This opens when the allowable pressure in the housing 7 is too high or too low. As a result, even as gases inside the housing 7 are consumed and/or recombined, or when gas passes rapidly from the anode into the housing under slight pressure, it is possible to ensure that prespecified pressure limits are maintained inside the housing 7, such that it is possible to prevent damage to the housing. A note for clarification: The fuel cell system is designed to be highly pressure stable in all pressure directions. No damage is possible within the scope of inventive processes. However, the housing can potentially be sensitive to pressure differences with respect to the atmosphere, primarily if it has a weight-saving and therefore thin-walled design.

As a result of the partially or entirely sealed housing with the valve devices 18 and/or 19 in the region of the ventilation connections 8, 9 and the very small length of the housing seal compared to the total length of the seals in the fuel cell system, a construction is achieved which can maintain the state in which hydrogen is present both in the interior of the fuel cell stack 3 and in the interior of the housing 7 over a very long period of time. Experiments have shown that in conventional constructions, periods of a few hours, for example two to three hours, are known and conventional. In the case of the construction of the fuel cell system described here, it would be possible to realize much longer time periods—for example time periods of more than 10 hours, up to more than 24 hours.

This is particularly true if the volume of hydrogen is dosed to the fuel cell system 1 in such a manner that a hydrogen atmosphere is reliably and consistently present both in the housing 7 and in the fuel cell stack 3, without the need to add extra hydrogen. This is advantageous with respect to the consumption of hydrogen, on the one hand, and on the other with respect to safety, because topping up the fuel cell system 2 with hydrogen during the system standby is an undesirable measure. This is because the system should be operated as much as possible without the presence of operating personnel or a driver of the vehicle 1.

The advantage of the construction and the described method is that of being able to prevent damaging gas exchanges on the anode end when the fuel cell system 2 is restarted, thereby being able to achieve a much longer service life of the fuel cell stack 3 by preserving the catalyst electrodes, which contain precious metals and therefore are high-cost, using very simple means and measures. In contrast to the measures and constructions of the prior art, the fuel cell system 2 can be realized easily and efficiently.

1.-10. (canceled)

11. A fuel cell system, comprising:
a fuel cell stack which is disposed in a housing, wherein the housing has a ventilation connection to surroundings or to a volume and wherein the ventilation connection has a valve device;
wherein the housing is made of at least two housing parts between which a housing seal is disposed and wherein a length of the housing seal is less than a total length of seals in the fuel cell system by a factor of more than 100.

12. The fuel cell system according to claim 11, wherein the housing is connected via a valve which opens and/or closes according to pressure to the surroundings or to a compensation volume.

13. The fuel cell system according to claim 11, further comprising a catalytic recombination device for converting oxygen and hydrogen into water, wherein the catalytic recombination device is disposed in the housing.

14. The fuel cell system according to claim 11, wherein a cathode chamber of the fuel cell stack is equipped with an air intake line and an air outlet line and wherein the air intake line and/or the air outlet line is closable via a respective shut-off valve device.

15. The fuel cell system according to claim 11, wherein a cathode chamber of the fuel cell stack is equipped with an air intake line and an air outlet line and wherein the air intake line is connectable connected to the air outlet line via a system bypass valve.

16. A method for switching off a fuel cell system according to claim 11, comprising the steps of:
halting an air feed to a cathode chamber;
after the air feed has been halted, closing the valve device in the ventilation connection and closing a respective shut-off valve device in an air intake line and/or an air outlet line of the cathode chamber; and
conveying hydrogen into an anode chamber of the fuel cell stack up to a prespecified pressure or a prespecified hydrogen volume.

17. The method according to claim 16, wherein before, during, and/or after the conveying of hydrogen, oxygen present in the cathode chamber is at least partially depleted.

18. The method according to claim 16, wherein the prespecified pressure or the prespecified hydrogen volume is at least large enough so that oxygen present in the fuel cell stack and the housing can fully react with the hydrogen.

19. A method of using the fuel cell system according to claim 11 in a vehicle, comprising the step of using the fuel cell system to provide electrical drive power.
